(19) United States
(12) Patent Application Publication
(10) Pub. No.: US 2009/0138097 A1
(43) Pub. Date: May 28, 2009

(54) METHOD AND SOFTWARE PRODUCT FOR MANAGING DATA EXCHANGE IN A HIGH-DYNAMICS SAFETY-CRITICAL SYSTEM

(76) Inventor: Pier Paolo Rinaldi, San Mauro Torinese (IT)

Correspondence Address: OSTROLENK FABER GERB & SOFFEN, 1180 AVENUE OF THE AMERICAS, NEW YORK, NY, 100368403, US

(21) Appl. No.: 11/817,551

(22) PCT Filed: Mar. 3, 2006
(86) PCT No.: PCT/IB06/00475

§ 371 Date: Jun. 12, 2008

(30) Foreign Application Priority Data
Mar. 4, 2005 (EP) 05425123.6

(51) Int. Cl. G05B 11/01; G06F 9/54; G06N 5/02; G06F 17/30

(52) U.S. Cl. 700/17; 719/312; 706/46; 707/9; 707/E17.005; 707/E17.044

(57) ABSTRACT

Disclosed herein is a high-dynamics safety-critical system, comprising a plurality of apparatuses, a plurality of interface devices through which a user can interact with the apparatuses, and a control computer connected to the apparatuses and the interface devices and on which there is installed a software product designed to implement and manage the data exchange between management modules for the apparatuses and management modules for the interface devices, in which the management modules for the interface devices acquire the selections made by a user via the interface devices, the selections are then transformed into commands for the apparatuses, and the commands thus generated are then stored in a shared database in such a way as to be usable by the management modules of the apparatus and actuated on the latter.

### TECHNICAL FIELD

The present invention relates in general to the management of data exchange in a high-dynamics system, namely a system where data processing cycle times of less than ten thousandths of a second are required, operating in a critical context for property safety and above all personal safety, particularly in a context where various kinds of electronic devices, such as, for example, computers and electronic equipment for actuation, measurement and control, displaying and monitoring, are present and on which software applications are loaded, the faults of which could, in addition to producing considerable damage to property, also put human lives at risk.

More in detail, the present invention concerns a method and a software product for the management of data usage between data-producer software modules and data-consumer software modules in a high-dynamics system operating in a critical context for personal and property safety.

The present invention can find useful application in countless technological sectors of which, purely by way of non-limitative example, the aeronautical field can be mentioned, and more specifically avionic systems for aircrafts, the railway field, and more specifically management and control systems for high-speed electric trains, the nautical field, and more specifically management and control systems for hydrofoils, the field of nuclear power plants, and more specifically the control system for the reactor core, etc.

### BACKGROUND ART

As is known, high-dynamics safety-critical systems can, in general, include a plurality of electronic apparatuses, such as sensors and actuators, and a central control system, in turn comprising a plurality of human-machine interface devices (HMI) through which a user, for example an operator of the reference platform (an aircraft pilot in the case of an aircraft platform), can interact with the electronic equipment, for example, to make selections or issue commands, by means of a central control computer connected to the electronic equipment and the human-machine interfaces via a communications bus.

The electronic apparatuses, such as sensors and actuators, and the human-machine interface devices exchange data via a software application, which is loaded on the central control system and implements a direct relation of use between the software management modules associated with the human-machine interface devices and the software management modules associated with the corresponding electronic apparatus.

One of the main limitations of this type of data exchange mechanism between the software management modules associated with the human-machine interface devices and the software management modules associated with the electronic apparatuses lies in the management of concurrent and conflicting access to the data of the same software management module associated with an electronic apparatus by different software management modules associated with respective human-machine interface devices. This problem is currently solved by using techniques of a semaphore type, through which access to the data of the same software management module, associated with an electronic apparatus, is enabled to more than one software management modules, associated with their respective human-interface devices, on the basis of pre-set priorities.

The main inherent drawback in using direct relations of use between software management modules associated with the human-machine interface devices and software management modules associated with the electronic apparatuses resides in the fact that, in the case a new electronic apparatus or a new human-machine interface device is added, or even when they are upgraded, it is necessary to take action on both the relations of use that involve these software management modules and on the management of concurrent accesses to the data, thereby rendering the software application insufficiently flexible and making the development, validation and certification times for safety-critical aspects extremely lengthy and onerous.

In the field of systems that operate in safety-critical contexts, made even more complex by the requirements requested for applications on high-dynamics platforms, the need is felt for the creation of a software architecture that allows the following design objectives to be achieved:
ability to implement a plurality of human-machine interface devices and a variety of sensors/actuators via an open and modular configuration, where the number of human-machine interface devices and the number of sensors/actuators are functions of the safety level, and therefore of the redundancy level, requested by the platform under development,
communication between a plurality of human-machine interface devices and sensors/actuators that is achieved through a plurality of instances of a same, uniquely-defined software class,
decoupling of the software architecture between the plurality of human-machine interface devices and the plurality of sensors/actuators that allows high maintainability of the software application and ease of expansion,
ability to solve possible access conflicts to the shared data structures, achievable through a rule/priority matrix, and
a software application in conformity with the necessary process requirements to support the certification procedures associated with safety-critical software applications, according to the RTCA-DO178B standard in the specific case of an aircraft.

### DISCLOSURE OF INVENTION

The purpose of the present invention is therefore that of providing a method and a software product for data exchange management in a high-dynamics system, namely a system where data processing cycle times of less than ten thousandths of a second are required, operating in a critical context for personal and property safety, which allows the drawbacks of known systems to be generally overcome, at least in part, and, more specifically, to achieve the above indicated design objectives.

According to the present invention there are provided a method and a software product for managing data exchange in a high-dynamics safety-critical system, as defined in the attached claims.

### BRIEF DESCRIPTION OF THE DRAWINGS

For descriptive simplicity and without loss of generality, the present invention will now be described with reference to one of its innumerable applications, in particular the aeronautical application, and with reference to the attached drawings, which illustrate a non-limitative example of embodiment, where:

FIG. 1 shows a block diagram of a mission-control apparatus of an aircraft,

FIG. 2 shows the architecture of a mission computer forming part of the mission-control apparatus of FIG. 1, and

FIG. 3 shows the module-based architecture of a software that runs on the mission computer of FIG. 2 and implements the management method according to the invention.

### BEST MODE FOR CARRYING OUT THE INVENTION

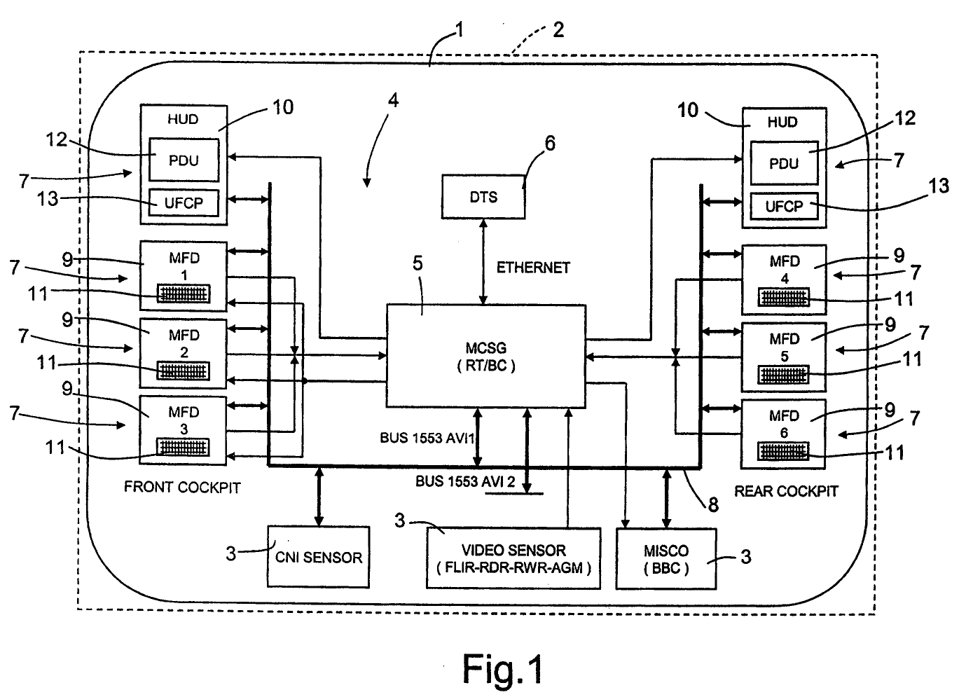

Illustrated schematically in FIG. 1, and designated as a whole by 1, is an avionic system of an aircraft 2 (represented schematically by a dashed line), for example an advanced training aircraft.

The avionic system 1 comprises a plurality of on-board apparatuses 3, such as, for example, communication navigation identification sensors (CNIs), video sensors (forward-looking infrared (FLIR), radar (RDR), radar warning receiver (RWR), etc.), weapon systems (air-to-ground missiles (AGM), etc.), interface and reversionary computing unit (MIScellanea COmputer—MISCO), etc., and a mission core system 4 comprising a mission computer (MCSG) 5, a data-transfer system (DTS) 6, connected to the mission computer 5 via an Ethernet cable for transferring mission databases and recording flight data, and a plurality of interface devices 7 connected to the mission computer 5 and to the on-board apparatuses 3 via an external bus 8 of the MIL-STD-1553B type for enabling a user, for example the pilot, to interact with the on-board apparatuses 3.

The interface devices 7 comprise a plurality of smart colour multifunction displays (SMFDs) 9 and head-up display units (HUDs) 10.

In particular, in advanced training aircraft, the smart colour multifunction displays 9 are preferably six in number, three for the front cockpit and three for the rear cockpit, are of the active-matrix liquid-crystal display (AMLCD) type, are provided with a keypad 11 for entry of data or for making selections, and have a 5″×5″ display area.

The head-up display units 10 can be two in number, one for the front cockpit and one for the rear cockpit, and each comprise a pilot display unit (PDU) 12 and a up-front control panel (UFCP) 13.

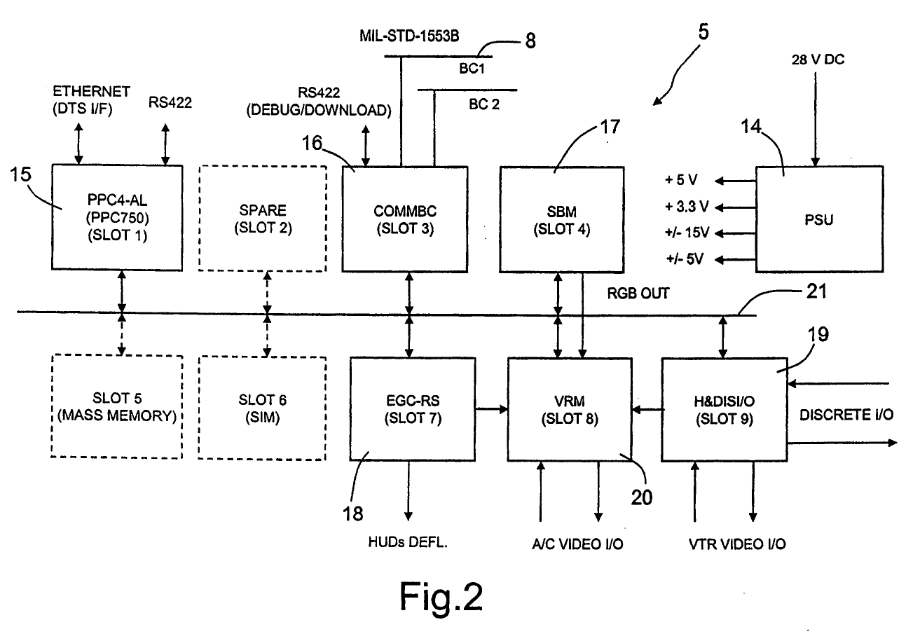

FIG. 2 illustrates the architecture of the mission computer 5, which comprises a power-supply unit (PSU) 14, a processing unit (PPC4-AL) 15 based upon a Motorola Power PC750 microprocessor, a communications unit (COMMBC) 16, which interfaces with the external bus 8, a digital map-generation unit (SBM) 17, a graphic-control unit 18 of the raster-stroke type (EGC-RS), designed to generate graphic symbols for the head-up display units 10, a HOTAS (Hands On Throttle And Stick) interface unit 19, a video-selection unit (VRM) 20, which is designed to receive signals from the digital map-generation unit 17, from the graphic-control unit 18 and from the HOTAS interface unit 19, and an internal-communication bus 21 shared between all the units of the mission computer 5 for the exchange of data.

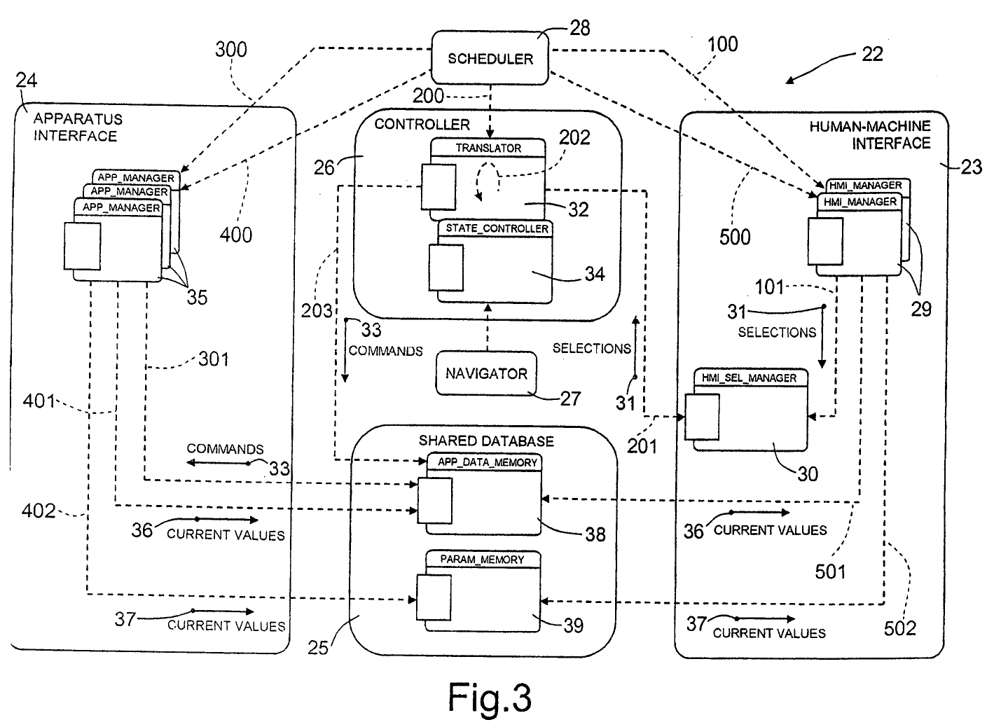

Loaded into the processing unit 15 is an operational flight program (OFP) 22, based upon a module-based architecture illustrated in FIG. 3 and compiled in a programming language known as Ada 95, which is based upon the use of the “protected-type” construct that guarantees an atomic access to the data and intrinsically solves the problem of protection from concurrent accesses in reading and writing by parallel processes.

In particular, with reference to FIG. 3, the operational flight program 22 can conceptually be divided into the following software objects:
a software object, hereinafter referred to, for reasons of convenience, with the name of human-machine interface 23, designed for virtualization of the interface devices 7;
a software object, hereinafter referred to with the name of apparatus interface 24, designed for virtualization of the on-board apparatuses 3;
a software object, hereinafter referred to, for reasons of convenience, with the name of shared database 25, designed for the storage of shared data between the human-machine interface 23 and the apparatus interface 24, such as primary-flight and aircraft parameters 2, operational states of the avionic system 1, and commands directed to the on-board apparatuses 3 and generated according to the selections made by the user;
a software object, hereinafter referred to, for reasons of convenience, with the name of controller 26, designed for the management of data exchange between the human-machine interface 23 and the apparatus interface 24;
a software object, hereinafter referred to, for reasons of convenience, with the name of navigator 27, designed for the execution of calculations and algorithms during the various steps of navigation, in a way in itself known and hence not described in detail; and
a software object, hereinafter referred to, for reasons of convenience, with the name of scheduler 28, designed for scheduling the operations executed by the various software objects, according to a logic sequence described in what follows.

The human-machine interface 23 comprises a plurality of modules 29 for managing the interface devices 7, and a module 30 for managing the selections made by the user. Each management module 29 is associated to a respective interface device 7 and creates a communication between the interface device 7 itself and the shared database 25.

In particular, each management module 29 is designed to: acquire a selection 31 made by the user via the keypad 11 of the corresponding interface device 7, the selection 31 of which can be constituted by a selection proper to a datum in a menu presented to the user or else by the entry of the datum itself; display on the corresponding interface device 7 graphic symbols representing the selection 31 made; and send the selection 31 made to the management module 30, which has the function of gathering all the selections 31 made by the user via the various interface devices 7 and of resolving possible concurrent accesses, conflicting or otherwise, to the on-board apparatuses 3.

The controller 26 comprises a translator module 32, designed to: acquire, via interrogation operations of a “select” type, the selections 31 gathered by the management module 30; convert said selections 31 into respective commands 33; and send the commands 33 to the shared database 25 via operations of writing of a “set” type. The controller 26 further comprises a state-controller module 34, designed to manage the state transitions of the avionic system 1 according to the selections 31 gathered by the management module 30 and according to calculations made by the navigator 27.

The apparatus interface 24 comprises a plurality of modules 35 for managing the on-board apparatuses 3, each of which is associated to a respective on-board apparatus 3 and creates a communication between the on-board apparatus 3 itself and the shared database 25. In particular, each management module 29 is designed to acquire, via interrogation operations of a “select” type, the commands 33 generated by the translator module 32 and directed to the respective on-board apparatus 3, and implement said commands 33 on the on-board apparatus 3 itself, appropriately handling any possible conflicts between the commands 33 and operational constraints of the on-board apparatus 3, modifying the execution of the commands 33 according to pre-defined criteria.

Said modifications are then transferred into the shared database 25, overwriting, via operations of writing of a “set” type, any possible parameters involved in these modifications, such as for example current operational parameters 36 of the on-board apparatuses 3 and general parameters 37, such as flight and/or aircraft parameters 2, and/or operational states of the avionic system 1.

The shared database 25 comprises a first module 38 for storing the current operational parameters 36 and the commands 33, and a second module 39 for storing the general parameters 37. The first storage module 38 and the second storage module 39 are interrogated by the management modules 29 for the purpose of acquiring the current operational parameters 36 and the general parameters 26 and displaying them on the interface devices 7.

In use, the scheduler 28 activates:
the human-machine interface 23 for acquiring the selections 31 made by the user on the interface devices 7 (100);
the controller 26 for acquiring the selections 31 from the human-machine interface 23 to convert them into respective commands 33 for the on-board apparatuses 3 and write the commands 33 in the shared database 25 (200);
the apparatus interface 24 for acquiring the commands 33 from the shared database 25 to implement them on the on-board apparatuses 3 (300), and for writing, in the shared database 25, the current operational parameters 36 and the general parameters 37, possibly modified following upon execution of the commands 33 (400); and finally
the human-machine interface 23 for acquiring the current operational parameters 36 and the general parameters 37 from the shared database 25 and displaying them on the interface devices 7 (500).

More in detail, when the pilot makes a selection 31 designed for a given on-board apparatus 3 via the keypad 11 of a corresponding interface device 7, the corresponding management module 29 produces a datum representing the selection 31 made, which is gathered (101) by the management module 30 to make the selection 31 usable by the translator module 32, which accesses (201) said selection 31 and converts it (202), through an appropriate validation depending upon the current operational state of the avionic system 1, into a corresponding command 33.

The command 33 thus generated is entered (203) into the first storage module 38 to make it usable by the module 35 for managing the on-board apparatus 3 to which the command 33 is destined. Next, the management module 35 accesses (301) the first storage module 38, takes up the command 33 and implements it on the corresponding on-board apparatus 3. In this a way, then, the module 35 for managing the on-board apparatus 3 “consumes” the datum initially “produced”, in the form of selection 31, by the module 29 for managing the interface device 7.

At this point, the module 35 for managing the on-board apparatus 3 “produces” a current operational parameter 36 regarding the on-board apparatus 3, and, possibly, a general parameter 37, such as a flight and/or aircraft parameter 2, and/or an operational state of the avionic system 1.

The current operational parameters 36 and the general parameters 37 are then entered (401, 402), respectively, into the first storage module 38 and into the second storage module 39, so as to render said current operational parameters 36 and general parameters 37 usable by those modules 29 for managing the interface devices 7 that are involved in the use of the current operational parameters 36 and general parameters 37 themselves. Next, the management modules 29 access (501, 502), without the intermediation of the translator module 32, the current operational parameters 36 and the general parameters 37, and display them on the respective interface devices 7. In this way, the modules 29 for managing the interface devices 7 become “consumers” of the data “produced”, in the form of current operational parameters 36 and of general parameters 37, by the module 35 for managing the on-board apparatus 3.

As may be noted, the logic sequence followed by the scheduler 28 conveys, by means of relations of use between the various modules, a datum between the human-machine interface 23 and the apparatus interface 24 along two distinct paths according to whether the datum produced is constituted by a selection 31, or else by a current operational parameter 36 or a general parameter 37.

From the above description, there is evident a function of decoupling performed by the management module 30, by the translator module 32, and by the shared database 25. In particular, the shared database 25 and the management module 30 function as passive objects in so far as they make available, by means of operations of “select” and “set”, the selections 31 and the commands 33 to the translator module 32, which functions, instead, as active object. Hence, said decoupling enables avoidance of direct relations of use for the exchange of a datum, constituted by a selection 31, a command 33, a current operational parameter 36, or else a general parameter 37, between a module 29 for managing an interface device 7, which initially is one for producing data and then becomes a consumer of data, and a module 35 for managing an on-board apparatus 3, which initially is a consumer of data and then becomes one for producing data.

This leads to the evident advantage that the addition of an on-board apparatus 3 or of an interface device 7 simply requires the addition of a respective management module 35 or 29 and possibly updating of mapping between selections 31 and commands 33 in the translator module 32 in so far as the relations of use between the human-machine interface 23, the shared database 25, and the controller 26 do not have to be modified.

Furthermore, the logic sequence followed by the scheduler 28 is shared in a finite number of concurrent processes with definite priorities and frequencies. In particular, the translator module 32 performs its tasks within a maximum-priority-and-frequency process, guaranteeing the correct logical sequence.

Finally, it should be noted that the construction of the operational flight program 22 in the programming language Ada 95 enables advantageous exploitation of the intrinsic characteristics of this programming language, i.e., atomic access to the data (selection 31, command 33, current operational parameter 36, or general parameter 37) and protection from concurrent accesses in reading and writing by parallel processes, for example by the modules 29, 32, 35, which, being created as “protected objects”, reinforce decoupling between the human-machine interface 23 and the apparatus interface 24.

Based on what has been described above, it is thus possible to immediately establish that the present invention achieves a software architecture that allows all of the above-indicated design objectives to be attained, namely:
ability to implement a plurality of human-machine interface devices and a variety of sensors/actuators via an open and modular configuration, where the number of human-machine interface devices and the number of sensors/actuators are functions of the safety level, and therefore of the redundancy level, requested by the platform under development,
communication between a plurality of human-machine interface devices and sensors/actuators that is achieved through a plurality of instances of a same, uniquely-defined software class,
decoupling of the software architecture between the plurality of human-machine interface devices and the plurality of sensors/actuators that allows high maintainability of the software application and ease of expansion,
ability to solve possible access conflicts to the shared data structures, achievable through a rule/priority matrix, and
a software application in conformity with the necessary process requirements to support the certification procedures associated with safety-critical software applications, according to the RTCA-DO178B standard in the specific case of an aircraft.

1. Method for managing data exchange in a high-dynamics safety-critical system (1) comprising at least one apparatus (3), an interface device (7) for said apparatus (3), and processing means (5) connected to said apparatus (3) and to said interface device (7) and on which a software product (22) is installed that is designed to implement and manage the data exchange between a first management module (29) of said interface device (7) and a second management module (35) of said apparatus (3) according to said method, said method comprising the phase of:
acquiring, by means of said first management module (29), a selection (31) made via said interface device (7), said method being characterized in that it comprises the additional phases of:
transforming (202) said selection (31) into a command (33) for said apparatus (3), and
storing (203) said command (33) in a shared database (25) in such a way as to make said command (33) usable by said second management module (35).

2. The method according to claim 1, further comprising:
accessing (301), by said second management module (35), said shared database (25) for acquiring said command (33); and
implementing said command (33) on said on-board apparatus (3).

3. The method according to claim 1, further comprising:
gathering (101) a plurality of selections (31) made via said interface device (7);
resolving possible conflicts between said selections (31); and
accessing (201) said gathered selections (31).

4. The method according to claim 1, wherein converting (202) said selection (31) into a command (33) comprises:
validating said selection (31) according to a current operational state of the said high-dynamics safety-critical system (1).

5. The method according to claim 1, further comprising:
storing (401, 402) data (36, 37) generated by said second management module (35) in said shared database (25) in such a way as to render said data (36, 37) usable by said first management module (29).

6. The method according to claim 5, further comprising:
accessing (501, 502), by said first management module (29), said shared database (25) for acquiring said data (36, 37); and
entering said data (36, 37) into said interface device (7).

7. The method according to claim 6, wherein entering said data (36, 37) into said interface device (7) comprises:
displaying said data (36, 37) on said interface device (7).

8. The method according to claim 5, wherein said data (36, 37) comprise a datum (36) regarding said on-board apparatus (3).

9. The method according to claim 5, wherein said data (36, 37) comprise a datum (37) regarding an operational state of said high-dynamics safety-critical system (1).

10. The method according to claim 5, wherein said shared database (25) comprises:
a first storage module (38) for storing commands (33) and data (36) regarding said on-board apparatus (3); and
a second storage module (39) for storing data (37) regarding the operational state of said high-dynamics safety-critical system (1).

11. Software product loadable in the memory of processing means (5) of a high-dynamics safety-critical system (1), and designed to implement, when executed, the method according to claim 1.

12. Software product according to claim 11, characterized in that it is embodied in the Ada 95 programming language.

13. High-dynamics safety-critical system (1) comprising at least one apparatus (3), an interface device (7) for said apparatus (3), and processing means (5) connected to said apparatus (3) and to said interface device (7), and on which a software product (22) according to claim 11 is installed.
